(19) United States
(12) Patent Application Publication
(10) Pub. No.: US 2011/0279903 A1
(43) Pub. Date: Nov. 17, 2011

(54) OPTICAL BEAM BUNDLE COMBINER FOR MULTIPLE LASER ARRAYS

(75) Inventors: Rudolf A. Wiedemann, Reno, NV (US); Kevin L. Lear, Fort Collins, CO (US); John R. Joseph, Carson City, NV (US)

(73) Assignee: TRILUMINA CORPORATION, Reno, NV (US)

(21) Appl. No.: 13/109,832

(22) Filed: May 17, 2011

Related U.S. Application Data
(60) Provisional application No. 61/345,513, filed on May 17, 2010.

(51) Int. Cl. G02B 27/10

(52) U.S. Cl. 359/618

(57) ABSTRACT

One or more combiner elements are disclosed for optically combining multiple laser beam bundles, either extra-cavity or intra-cavity to the laser generating array chips, to form higher density bundles of parallel laser beams. The combiner elements can be shared between two or more array chips and include a form of a pellicle combiner, a polarizing beam splitter cube combiner, or some combination of the two devices.

### CROSS-REFERENCES TO RELATED APPLICATIONS

This is a non-provisional application that takes priority from provisional application Ser. No. 61/345,513, filed 17 May 2010, which is incorporated herein by reference in its entirety.

### BRIEF DESCRIPTION OF THE INVENTION

One or more combiner elements are disclosed for optically combining multiple laser beam bundles, either extra-cavity or intra-cavity to the laser generating array chips, to form higher density bundles of parallel laser beams. The combiner elements can be shared between two or more array chips and include a form of a pellicle combiner, a polarizing beam splitter cube combiner, or some combination of the two devices.

### STATEMENTS AS TO THE RIGHTS TO INVENTIONS MADE UNDER FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISK

Not applicable.

### BACKGROUND OF THE INVENTION

There are many applications for bundles of laser beams from an array of emitters, whether that array is a stack of edge emitting laser diodes, surface emitting laser diodes, or vertical cavity surface emitting laser (VCSEL) arrays. These applications generally require high optical power, but in a small physical space. VCSELs have the advantage of being used to create monolithic arrays of laser emitters which greatly reduce the assembly cost of end products. A limiting factor when attempting to increase the density of laser emitters in an array so as to create a high-power bundle is the ability to provide sufficient drive current and cooling for the array.

Simply adding more emitters per unit area so as to achieve greater power only compounds the heat extraction and current supply problems. In addition, many of the applications for laser beam bundles, such as converging the bundle into a single fiber optic, requires that the beams in the bundle be in parallel. Simply adding more beams to the periphery of the bundle to make it larger will often be ineffective because there is a limit angle for beams being joined into the converged bundle, such as in a fiber optic coupling. Also, each beam must be of low divergence to allow reasonable distances between the emitter array and the downstream optics, or to facilitate the use of intermediate optical elements such as a micro-lens array, to shape the beams so as to better conform to the optical requirements of the system.

In the case of VCSEL arrays, their inherently low-divergence beams also facilitate the use of intra-cavity optics, where one or more of the resonator mirrors are not on the VCSEL chip. This gives rise to the possibility of placing one or more “optical combining” elements in the laser cavity, which increases the optical bundle density while simultaneously sharing the use of common optical elements among two or even more VCSEL array chips.

### BRIEF DESCRIPTION OF THE SEVERAL VIEWS OF THE DRAWING

FIG. 1 is an illustration of an embodiment of an extra-cavity pellicle reflector for combining beam bundles from two laser array chips into a single bundle;

FIG. 2 is an illustration of an embodiment of an intra-cavity polarization combiner;

FIG. 3 is an illustration of a pellicle for intra-cavity sharing of a common output coupler;

FIG. 4 is an illustration of a pellicle and polarization combiner being used in together to combine beams from more than two array chips;

FIG. 5 is a perspective view of a pellicle;

FIG. 6 is a perspective view of a polarizing beam splitter cube; and

FIG. 7 is a perspective view of an array of micro-lenslets.

### DETAILED DESCRIPTION OF THE INVENTION

Embodiments include one or more elements for optically combining multiple laser beams generated by two or more laser-emitting semiconductor devices so as to form higher density bundles of substantially parallel laser beams. While one-dimensional and two-dimensional arrays of edge-emitting laser diodes could be used as the laser source, such devices have less desirable beam divergence. Beam divergence is a measure for how fast the beam expands in the far field, i.e., far from the beam waist. VCSELs arrays, however, are ideally suited for use with combiners because such arrays generate beams having circular cross-sections and low divergence. For example, a downstream combiner, referred to as a pellicle combiner herein and further discussed below, is more appropriately used with the collimated beams generated by VCSEL arrays than with other more divergent output beam sources.

Embodiments disclosed herein can be used with semiconductor light devices including top emitting vertical-cavity surface emitting lasers (VCSELs), bottom emitting VCSELs, top emitting VCSELs with external cavities (VECSELs), and bottom emitting VECSELs. Embodiments can also be used with light-emitting diodes, edge emitting lasers, organic light-emitting diodes, optically pumped light sources, and electrically pumped light sources.

As noted, one of the combiners disclosed herein is referred to as a pellicle combiner. The term “pellicle” is usually used to refer to a thin film, membrane or skin. In the context of light manipulation, however, the term “pellicle” is usually used in reference to a pellicle mirror, which is a type of thin, semi-transparent mirror employed in the light path of an optical instrument to split a light beam into two separate beams, both of reduced light intensity. In contrast to the pellicle mirror, the pellicle combiner described herein is a thin device, typically formed from a flat glass surface, having a reflective surface, typically formed from a coating of a highly reflective metal, such as chrome, for reflecting a first bundle of beams from a first VCSEL array and having a pattern of holes through the reflective surface for passing through a second bundle of beams from a second VCSEL array so as to combine the first bundle with the second bundle.

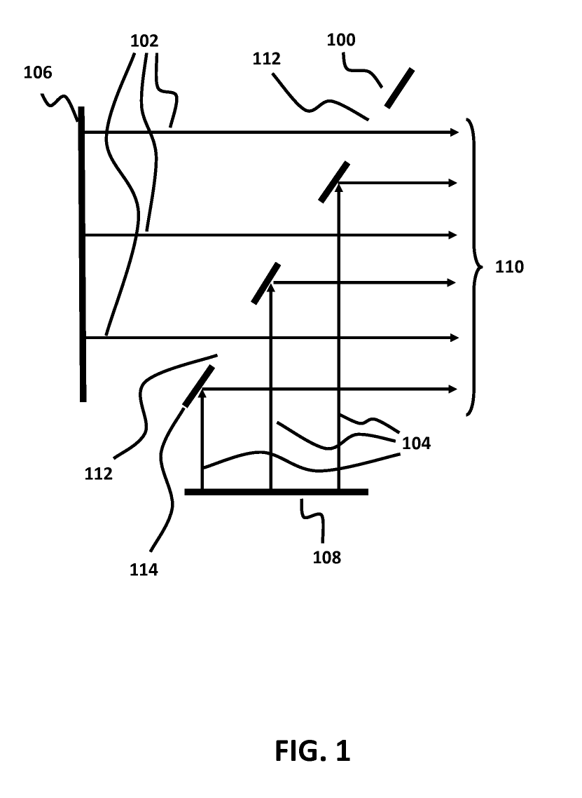

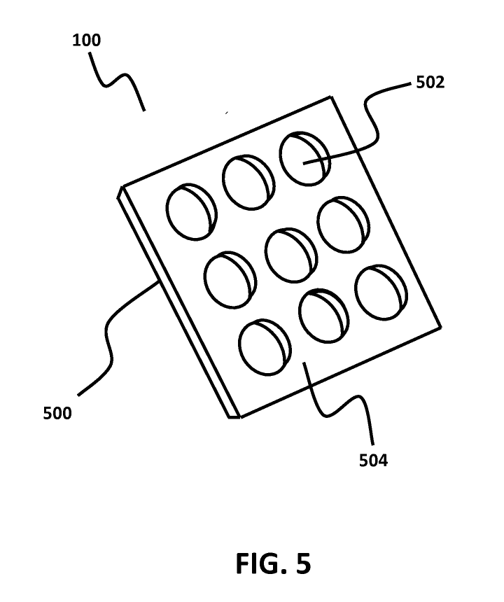

As illustrated in FIG. 1, the pellicle combiner is usually tilted at 45 degrees relative to the axis of the second beam bundle, and as illustrated in FIG. 5, the array of holes through the reflective surface are formed in such a way as to allow the beams from the second VCSEL array to cleanly pass thru it. As also illustrated in FIG. 1, the first VCSEL array is placed at 90 degrees relative to the second VCSEL array so that the first beam bundle reflects off the back surface of the pellicle combiner in those areas where there are no holes. The result is a higher density beam bundle, with twice the number of beams, all in parallel to each other.

The pellicle combiner illustrated herein can be used either intra-cavity or extra-cavity to combine the beam bundles. In particular, FIG. 1 illustrates an extra-cavity pellicle combiner 100 (shown in cross-section) for combining the beam bundles 102 and 104 from two laser array chips 106 and 108 into a single bundle 110 having the beam count of bundles 102 and 104. The pellicle combiner 100 has a reflective surface oriented at approximately 45 degrees to either bundle with an array of elliptical holes 112 so as to allow bundle 102 to pass while the rest of the surface 114 of pellicle combiner 100 reflects bundle 104. FIG. 5 further illustrates details of the pellicle combiner 100, which consists of a transparent substrate 500, such as glass, an array of elliptical holes 502, which are formed through the substrate at a 45 degree angle to the substrate 500 and whose pattern and center-to-center spacing matches that of the VCSEL array's VCSEL spacing, and a reflective coating 504, such as chrome, adhered to the substrate 500.

In FIG. 1, the pellicle combiner 100 is oriented at a substantially 45 degree angle, ensuring that the bundle 104 reflects at a 90 degree angle and results in the bundle 104 being parallel to the bundle 102. It is to be understood that the orientation of the pellicle combiner can be different than 45 degrees and will depend on the orientation of the first laser chip 106 and the second laser chip 108. It is also noted that the first laser chip 106 need not be oriented perpendicular to the second laser chip 108, what is important is for the pellicle combiner 100 be oriented such that the first bundle is allowed to pass through the array of elliptical holes 502 and the second bundle is reflected by the necessary degree angle to ensure that after reflection the second bundle is parallel to the first bundle.

In one embodiment, the second bundle emitted by a second laser chip can be reflected two or more times to ensure that after the two or more reflections, the second bundle is parallel to the first bundle emitted by the first laser chip. For instance, the arrangement of a device may make it necessary for the first laser chip to have a first orientation, resulting in a first bundle of laser beams being emitted in a first direction, and a second laser chip to have a second orientation that is not perpendicular to the first laser chip, resulting in a second bundle of laser beams emitted in a second direction. In such a device, it may be necessary for either the first bundle of laser beams or the second bundle of laser beams, or both the first bundle and the second bundle to be reflected one or more times to ensure that the first bundle and the second bundle are oriented parallel after all of the reflections so that these two laser bundles can be combined into a single bundle of laser beams.

A second type of combiner disclosed herein uses the notion that two beams (or beam bundles) that are optically polarized at 90 degrees to each other can be combined in a “polarizing beam splitter” cube where the vertically polarized bundle (relative to the reflecting surface of the combiner cube) passes through the combiner cube, and the horizontally polarized bundle reflects off the back side of the combiner cube's polarizing reflector to form a set of co-incident and parallel beams having both vertical and horizontal polarization as well as their combined power. When this type of combiner is used within the laser cavity, the polarizing combiner cube can also serve as a strong polarization selecting element so as to allow only photons of the appropriate polarization to be amplified.

An “output coupler” element, which is shared by the output beam bundles of the combiner cube, can consist of a piece of flat optical material such as glass, with a partially-transparent reflective coating on one side to form the optical resonator for the combined beam bundle. This same surface can also accommodate other devices such as a micro-lens array or a micro-mirror array whose individual elements are matched to each laser beam in the bundle. The flat optical material of the output coupler could also be made of a frequency-doubling crystal with a partially-transparent reflective coating on the far side of the crystal to make the crystal intra-cavity. Micro-lens arrays on the output coupler are used in favor of micro-concave-mirror arrays because micro-lenses will re-collimate each beam in the bundle, which facilitates an output coupler coating on a simple flat surface rather than on the micro-concave-reflectors. While the use of a glass substrate for the output coupling element is adequate, using a substrate comprised of a frequency-doubling crystal can provide a new capability for creating other wavelengths.

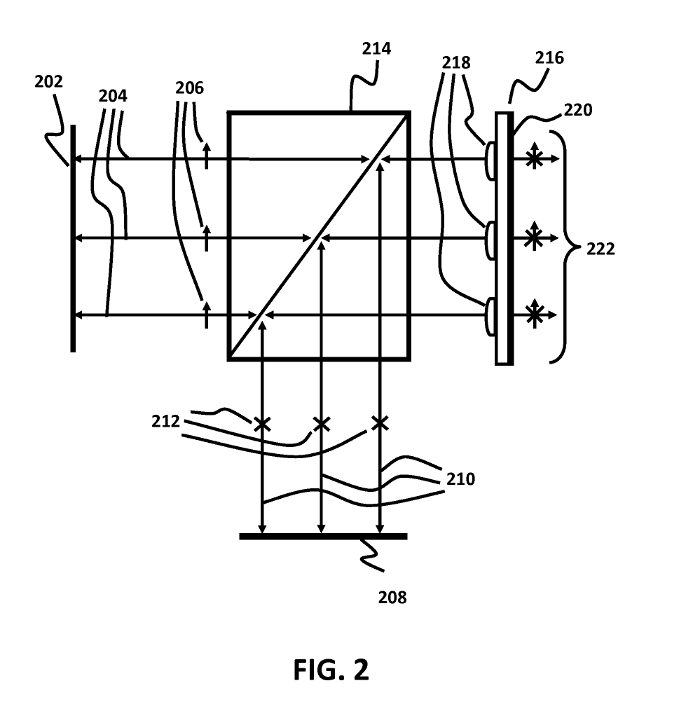

The combiner cube and output coupler described above are further illustrated in FIG. 2, which depicts an intra-cavity polarization combiner, where beam bundle 204 from array chip 202 is polarized in the plane of the drawing, illustrated by the arrows 206, and beam bundle 210 from array chip 208 is polarized perpendicular to the plane of the drawing, illustrated by the X's 212. Polarizing cube 214 serves both to combine the two orthogonally-polarized bundles and to select the appropriate polarized light to be amplified in each laser array chip. Output coupler 216 is comprised either of glass or a frequency-doubling crystal with an optional micro-element optical array 218, and has a partially-transparent reflective coating 220 on the outside of the cavity to complete the laser resonator cavity. In this configuration, the resulting output beam bundle 222 has the same number of beams as either bundle 204 or 210 but contains both polarizations for a total power of the sum of each bundle 204 plus 210. Ideally, the polarizing beam-splitter cube 214 has an anti-reflection coating on all outer surfaces for the laser wavelength being used.

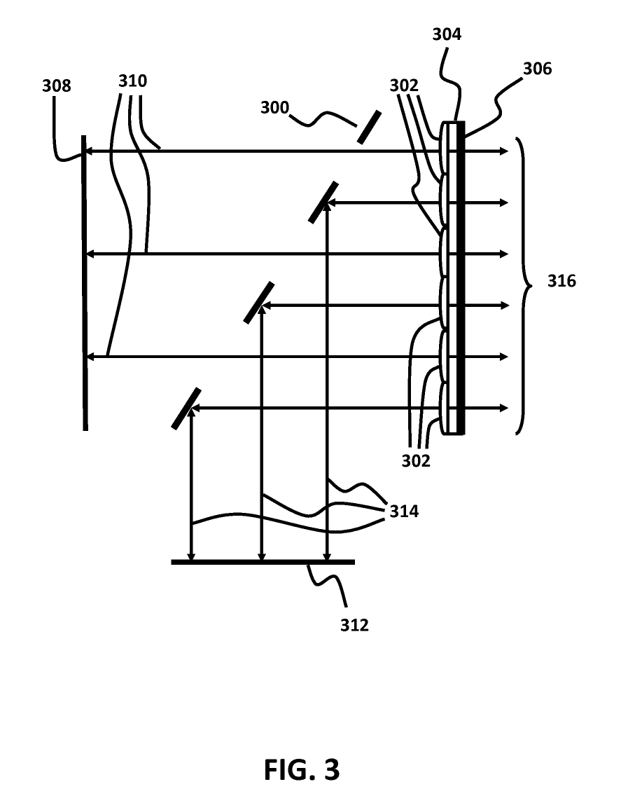

FIG. 3 describes the use of a pellicle combiner 300 for intra-cavity sharing of a common output coupler 302/304/306. In this configuration there are twice as many micro-lens elements 302 because the first beam bundle 310 emitted by the first laser chip 308 and the second beam bundle 314 emitted by the second laser chip 312 are not combined coincidentally but rather interleaved into bundle 316.

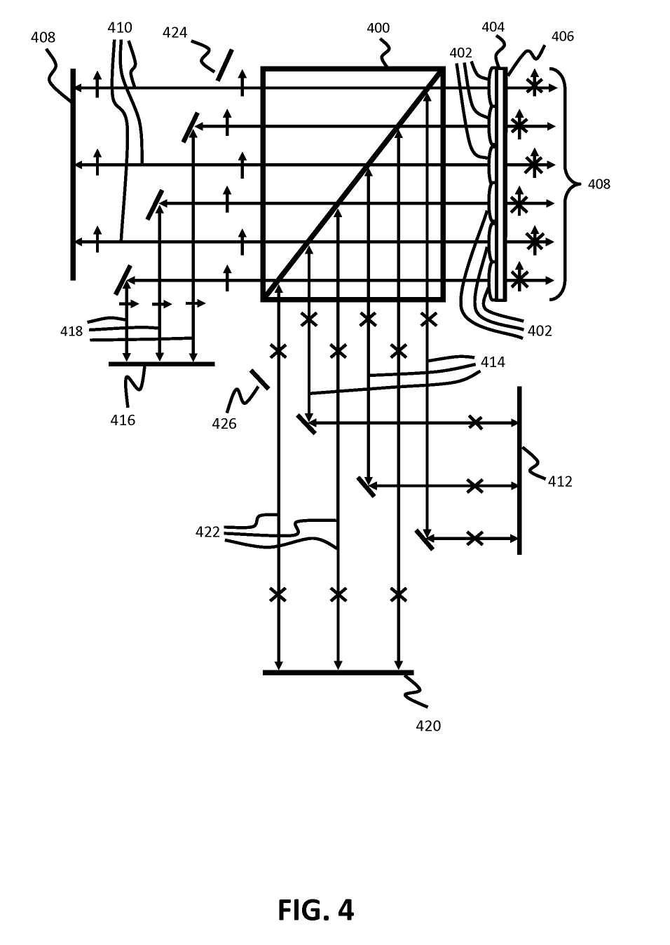

A combination of pellicle combiners and polarizing element combiners can also be used to combine laser beam bundles from more than two laser array chips. The distribution of the laser arrays among two or more laser chips facilitates the distribution of heat and the supply of current to each device as opposed to constraining the combined heat and electrical power to one chip. This combination is further illustrated in FIG. 4. In this configuration, both the polarizing beam splitter 400 and the output coupler 402/404/406 are common to the entire system. The polarizing beam splitter 400 combines the first laser bundle 410 emitted by the first laser chip 408 with the second laser bundle 414 emitted by the second laser chip 412. The polarizing beam splitter 400 also combines the third laser bundle 418 emitted by the third laser chip 416 with the fourth laser bundle 422 emitted by the fourth laser chip 420. The output beam bundle 408 contains a beam count equal to the sum of beam bundles 410 and 418, has both vertical and horizontal polarized components, and carries the sum power output of all array chips 408, 412, 416 and 420. The use of a single common polarizing beam-splitter cube 400 along with multiple pellicles 424 and 426 is useful because pellicles can be fabricated less expensively than beam-splitter cubes. While FIG. 4 illustrates the use of four laser array chips, alternative embodiments can comprise three laser array chips or more than four laser array chips, with one or more pellicles used to combine all or a subset of the beam bundles emitted by the laser array chips.

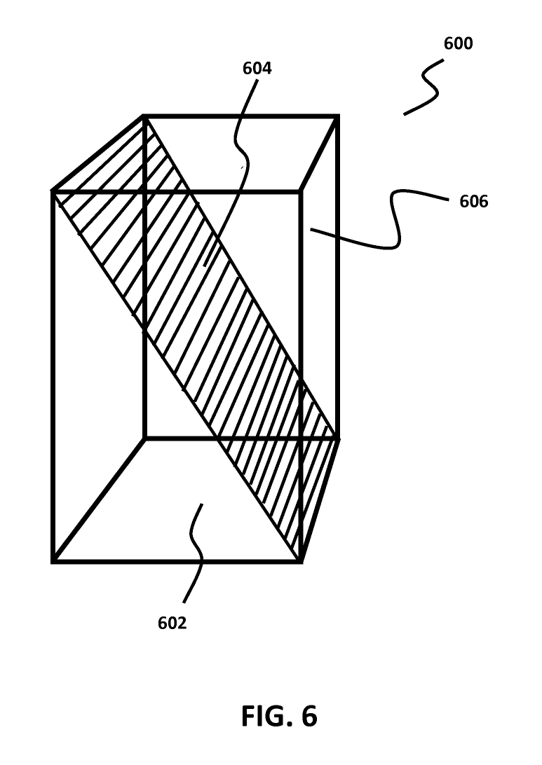

FIG. 6 further illustrates a polarizing beam splitter cube 600, which consists of a glass wedge 602 cut at 45 degrees with a polarizing layer or coating 604. Another similar coating-free glass wedge 606 is then bonded to wedge 602 with clear optical cement (not shown) to form a cube.

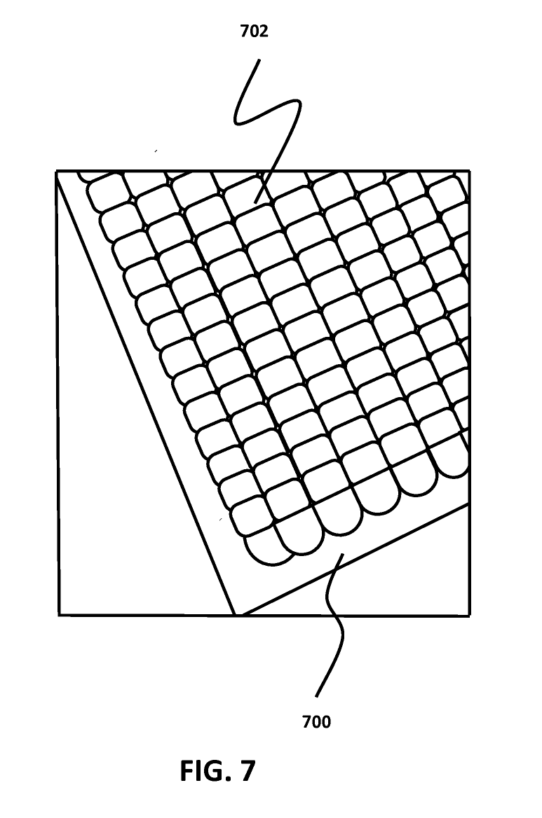

FIG. 7 depicts an array of micro-lenslets 702 formed by coating substrate 700 with droplets of clear material and then melting them together, or by etching the substrate to form suitable lenslet elements. Substrate 700 can be transparent such as glass, or be an optical crystal substance for the purpose of frequency-doubling.

Hence, while a number of embodiments have been illustrated and described herein, along with several alternatives and combinations of various elements, for use in geo-reinforcing, it is to be understood that the embodiments described herein are not limited to the embodiments shown and can have a multitude of additional uses and applications. Accordingly, the embodiments should not be limited to just the particular descriptions, variations and drawing figures contained in this specification, which merely illustrate a preferred embodiment and several alternative embodiments.

What is claimed is:

1. A laser beam bundle combiner, comprising:
a first laser emitting device emitting a first bundle of laser beams in a first direction;
a second laser emitting device emitting a second bundle of laser beams in a second direction substantially perpendicular to the first direction; and
a pellicle combiner including a flat glass piece having a position substantially 45 degrees relative to the first direction and the second direction, a reflective surface for reflecting the second bundle of laser beams in the first direction, and a pattern of holes through the flat glass piece and the reflective surface for allowing the first bundle of laser beams to pass through the flat glass piece and combine substantially parallel with the second bundle of laser beams.

2. The combiner as recited in claim 1, wherein the first laser emitting device and the second laser emitting device include a top emitting vertical-cavity surface emitting laser (VCSEL), a bottom emitting VCSEL, a top emitting VCSEL with external cavities (VECSEL), and a bottom emitting VECSEL.

3. The combiner as recited in claim 1, wherein the first laser emitting device and the second laser emitting device include a light-emitting diode, an edge emitting laser, an organic light-emitting diode, an optically pumped light source, and an electrically pumped light source.

4. The combiner as recited in claim 1, further comprising an output coupler having a flat optical material layer on a first side of the output coupler and having a first facing orientation facing the pellicle combiner, and a reflective coating on a second side of the output coupler having a second facing orientation opposite the first facing orientation.

5. The combiner as recited in claim 4, wherein the flat optical material layer is made of glass.

6. The combiner as recited in claim 4, wherein the flat optical material layer is a frequency-doubling crystal.

7. The combiner as recited in claim 4, wherein the output coupler further comprises a micro-element optical array, wherein each individual element among the micro-element optical array is matched to each laser beam from the first bundle of laser beams and the second bundle of laser beams.

8. The combiner as recited in claim 7, wherein the micro-element optical array includes a micro-lens array and a micro-mirror array.

9. A laser beam bundle combiner, comprising:
a first laser emitting device emitting a first bundle of laser beams in a first direction;
a second laser emitting device emitting a second bundle of laser beams in a second direction; and
a pellicle combiner including a flat glass piece having a pattern of holes and a reflective surface for reflecting the second bundle of laser beams, the pellicle combiner positioned at an angle relative to the first direction and the second direction enabling the first bundle of laser beams to pass through the pattern of holes and the second bundle of laser beams to be reflected by the reflective surface from the second direction to the first direction, the pellicle combiner combining substantially parallel the first bundle of laser beams with the second bundle of laser beams.

10. A laser beam bundle combiner, comprising:
a first laser emitting device emitting a first bundle of laser beams in a first direction, the first bundle of laser beams having a first polarization;
a second laser emitting device emitting a second bundle of laser beams in a second direction substantially perpendicular to the first direction, the second bundle of laser beams having a second polarization substantially perpendicular to the first polarization; and
a glass cube having a polarizing layer having a position substantially 45 degrees relative to the first direction and the second direction, the polarizing layer allowing the first bundle of laser beams to pass through the polarizing layer while the second bundle of laser beams is reflected in the first direction to form a bundle of co-incident and parallel beams having both a vertical and a horizontal polarization and the combined power of the first bundle of laser beams and the second bundle of laser beams.

11. The combiner as recited in claim 10, wherein the first laser emitting device and the second laser emitting device include a top emitting vertical-cavity surface emitting laser (VCSEL), a bottom emitting VCSEL, a top emitting VCSEL with external cavities (VECSEL), and a bottom emitting VECSEL.

12. The combiner as recited in claim 10, wherein the first laser emitting device and the second laser emitting device include a light-emitting diode, an edge emitting laser, an organic light-emitting diode, an optically pumped light source, and an electrically pumped light source.

13. The combiner as recited in claim 10, further comprising an output coupler having a flat optical material layer on a first side of the output coupler and having a first facing orientation facing the glass cube, and a reflective coating on a second side of the output coupler having a second facing orientation opposite the first facing orientation.

14. The combiner as recited in claim 13, wherein the flat optical material layer is made of glass.

15. The combiner as recited in claim 13, wherein the flat optical material layer is a frequency-doubling crystal.

16. The combiner as recited in claim 13, wherein the output coupler further comprises a micro-element optical array, wherein each individual element among the micro-element optical array is matched to each laser beam from the first bundle of laser beams and the second bundle of laser beams.

17. The combiner as recited in claim 16, wherein the micro-element optical array includes a micro-lens array and a micro-mirror array.

18. The combiner as recited in claim 10, wherein the glass cube further comprises an anti-reflection coating on a plurality of outer surfaces of the glass cube for a particular laser wavelength.

19. The combiner as recited in claim 10, further comprising:
a third laser emitting device emitting a third bundle of laser beams in the second direction; and
a pellicle combiner including a flat glass piece having a second position substantially 45 degrees relative to the first direction and the second direction, a reflective surface for reflecting the third bundle of laser beams in the first direction, and a pattern of holes through the flat glass piece and the reflective surface for allowing the first bundle of laser beams to pass through the flat glass piece and combine substantially parallel with the third bundle of laser beams.
